(19) United States
(12) Patent Application Publication
(10) Pub. No.: US 2012/0264521 A1
(43) Pub. Date: Oct. 18, 2012

(54) INTERNET FAMILY HISTORY GAME INTERACTING WITH DATABASES

(75) Inventors: Jeffrey L. Wells, Mapleton, UT (US); Scott C. Pugh, West Valley City, UT (US); Ross S. Wolfley, Alpine, UT (US)

(73) Assignee: FUNIUM, LLC, Draper, UT (US)

(21) Appl. No.: 13/493,881

(22) Filed: Jun. 11, 2012

Related U.S. Application Data
(63) Continuation-in-part of application No. 13/088,428, filed on Apr. 18, 2011.

(51) Int. Cl. G06F 17/00

(52) U.S. Cl. 463/42

(57) ABSTRACT

An family history game in which progress is measured at least partially by a player's family history research. In some embodiments, the family history game may comprise a computer game that may be played online to facilitate interaction between a player and a database. The player may use avatars that represent real people, who may or may not be related to or otherwise associated with the player. The player may retrieve documents or other information from searching one or more online databases that include information about a real person who corresponds to an avatar used by the player. Multiple players may interact with one another in the family history game through online social media. User-provided content may be provided by the players and shared with other players of the family history game.

### CROSS REFERENCE TO RELATED APPLICATION

This application is a continuation-in-part of U.S. patent application Ser. No. 13/088,428 entitled “Internet Family History Game Interacting with Databases,” filed Apr. 18, 2011, pending, the disclosure of which is hereby incorporated by reference in its entirety.

### FIELD

Embodiments of the present disclosure relates generally to processes and means for performing family history, or genealogical, research. More specifically, the embodiments of the present disclosure relate to methods, means and systems in which family history information is researched and gathered from a variety of sources. In various embodiments, the methods, means and systems of the present disclosure may be embodied as games for researching and gathering family history information. In a specific embodiment, a game that incorporates teachings of the present disclosure employs Internet-based research.

### BACKGROUND

In the past, research into family history or genealogy has often been considered a difficult and boring pastime that usually yields only a list of names and dates. With the coming of the computer era, it has become easier to do family history research. However, many are daunted by the task of learning to use a computer and searching through cryptic historic databases on the Internet. Consequently, the task of family history research remains a formidable and unwelcome activity for the majority of the masses.

There have been attempts to make family history into a game. See, e.g., U.S. Pat. No. 3,970,313 (Montemayor), issued Jul. 20, 1976. However, such games usually remain complicated and difficult and do not involve interacting with real historic databases.

### BRIEF SUMMARY

Embodiments of the present disclosure may include an online family history gaming network. The online family history gaming network may comprise a game server configured to execute an online family history game that enables a player to control one or more avatars in a virtual world. Each avatar represents a real person. The online family history gaming network may further comprise an internal database configured to store and manage real-world information associated with the real person represented by each avatar.

Embodiments of the present disclosure may include a method for managing family history information of a player of an video game. The method comprises associating real-world information for a plurality of avatars representing real people in a virtual world, querying at least one database for the real-world information in response to a request from a player of a family history game, and sending the real-world information to the player responsive to the request.

### BRIEF DESCRIPTION OF THE DRAWINGS

In the detailed description that follows, reference will be made to the following Figures, in which:

FIG. 1 is a computer screen view of an online family village screen according to described embodiments of the present disclosure;

FIG. 2 is a computer screen view of an online dashboard with controls and access to other screens, according to the embodiments shown in FIG. 1;

FIG. 3 is a partial view of the computer screen shown in FIG. 1;

FIG. 4 is a computer screen view of an online family tree screen according to described embodiments of the present disclosure;

FIGS. 5, 6, and 7 are computer screen views of an online family tree screen according to described embodiments of the present disclosure;

FIG. 8 is a partial computer screen view of an online edit family tree screen according to described embodiments shown in FIGS. 5, 6, and 7;

FIG. 9 is a computer screen view of an online family library screen according to described embodiments of the present disclosure;

FIG. 10 is a computer screen view of an online family tree search results screen according to the embodiments shown in FIG. 9;

FIG. 11 is a computer screen view of an online comparison search screen according to the embodiments shown in FIG. 9;

FIG. 12 is a computer screen view of an online document screen according to the embodiments shown in FIG. 9;

FIG. 13 is a flow diagram showing various acts that may be conducted in a search for data related to a male, according to described embodiments of the present disclosure;

FIG. 14 is a flow diagram showing various acts that may be conducted in a search for data related to a female, according to described embodiments of the present disclosure;

FIG. 15 is a flow diagram showing various acts that may be conducted in a search for according to search parameters that lists results according to results rating, according to described embodiments of the present disclosure;

FIG. 16 is computer screen view of an online family village screen according to described embodiments of the present disclosure;

FIG. 17 is a computer screen of an online store screen, according to described embodiments of the present disclosure;

FIGS. 18 and 19 are partial computer screens of a villager, according to described embodiments of the present disclosure;

FIG. 20 is a computer screen of a monument sub-screen of an online store screen, according to described embodiments of the present disclosure;

FIG. 21 is an online family history gaming network according to an embodiment of the present disclosure;

FIG. 22 is a screen shot of a family archive window of the Family Village game;

FIG. 23 is a screen shot of a villager museum that may be opened for a particular villager;

FIG. 24 is a screen shot of a content book associated with a villager;

FIG. 25 is a screen shot of an explorer window that may be opened responsive to the player selecting the add button of FIG. 24;

FIG. 26 is a screen shot of a viewing window that may be opened responsive to a file being selected;

FIG. 27 is a screen shot of the viewing window that may be opened responsive to an associate button being selected; and

FIG. 28 is a screen shot of the content book showing the newly added user-provided content in one of the content locations.

### DETAILED DESCRIPTION

In the present disclosure, as described in the following embodiments, provides a number of advantages over the existing prior art. In a specific embodiment, the present disclosure includes a computer game that accesses one or more databases from which a player can retrieve documents or other information for use in the game. In some embodiments, the player may add documents or other information for use in the game, which documents and information may be made available to other players of the game.

As part of the game, each player sets up a village with villagers, who may be based on real-life relatives and ancestors of the player or on people who may not be related to the player.

When played, a computer-based embodiment of a game of the present disclosure may interact with real-world search tools and databases to provide real-world documents and information that can be used in the game. This interaction may be performed through interaction by the player with historic databases (e.g., databases used to locate family history or ancestral information, etc.), to retrieve various documents and other information regarding each villager in the game. In some embodiments, the real-world documents may be included in a database maintained by the game itself. For example, players may upload real-world documents and other information associated with villagers in the game (who, themselves, may be based on real-life relatives ancestors of the player).

Among various embodiments are online games. An online game may be accessed and played in connection with a social network website, such as FACEBOOK®, thereby involving interactions with others on the social network. Further, in embodiments where the game is played in a social networking environment, different players at remote locations from one another may be interconnected, enabling each player to visit the villages of the other players and interact with those villages. Players are able to enjoy a competitive and cooperative game, called “Family Village,” on a social network on the Internet, which involves other players in a competitive and cooperative manner and which provides for the retrieval of important real-world documents and information for the actual relatives and ancestors of each game player.

As used herein, the word “he” means “he” or “she” and the word “him” means “him” or “her.”

The various illustrative logical blocks, modules, and circuits described in connection with the embodiments disclosed herein may be implemented or performed with a processor such as a general purpose processor, a special purpose processor, a Digital Signal Processor (DSP), an Application-Specific Integrated Circuit (ASIC), a Field-Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media, including any medium that facilitates transfer of a computer program from one place to another.

### Overview

Family Village includes several main components, including each player's Family Village, a Family Tree Builder and the player's Family Library. The basic game play consists of immigrating a playing piece or avatar representative of the player and other avatars representative of the player's relatives into the player's Family Village and assigning them jobs to create family prosperity. The avatars or villagers can also pursue career paths chosen by the player and gain status in the village and among the player's FACEBOOK® friends.

During the game the player and the game will search for real-world documents about the relatives related to the avatars or villagers. As each player builds his own Family Village at his own computer, he can arrange to make online visits to the Family Villages of other players and assist other players in building their villages. Each player can play at increasing levels, each level allowing the player to immigrate more villagers.

In Family Village, the player will build out his/her actual family tree, and then immigrate those family members into a village designed and built by the player. The player will assign jobs to the avatars representative of the player's ancestors, to earn money for the player's village to grow. The player can buy homes, cars, pets, and decorations from the time in which his/her ancestors lived. The player can even buy monuments that show off his/her unique ancestral heritage.

As the player's village grows, the game will be working behind the scenes to find family connections and interesting documents such as newspaper articles, yearbook photos, census records, marriage records, maps and many other interesting items that will allow the player to know much more about his/her family. The player will be able to save these documents in the village library and share them with other friends and family as desired.

### The Family Village

A player may enter the Family Village game by accessing a social medium (e.g., FACEBOOK®, etc.). The player's personal information is entered into the game (e.g., manually, by importing the same from the social medium, etc.). Such personal information may include the player's name, birth date, and an image. That player becomes the first villager, “villager one,” in the player's Family Village. The player can tailor the look of his avatar (e.g., choose his appearance, including eye and hair color, facial hair (if any), clothing, hat, etc.). Each villager can improve his status in a number of ways that will be detailed hereafter, which in turn will improve the status and prosperity of the village.

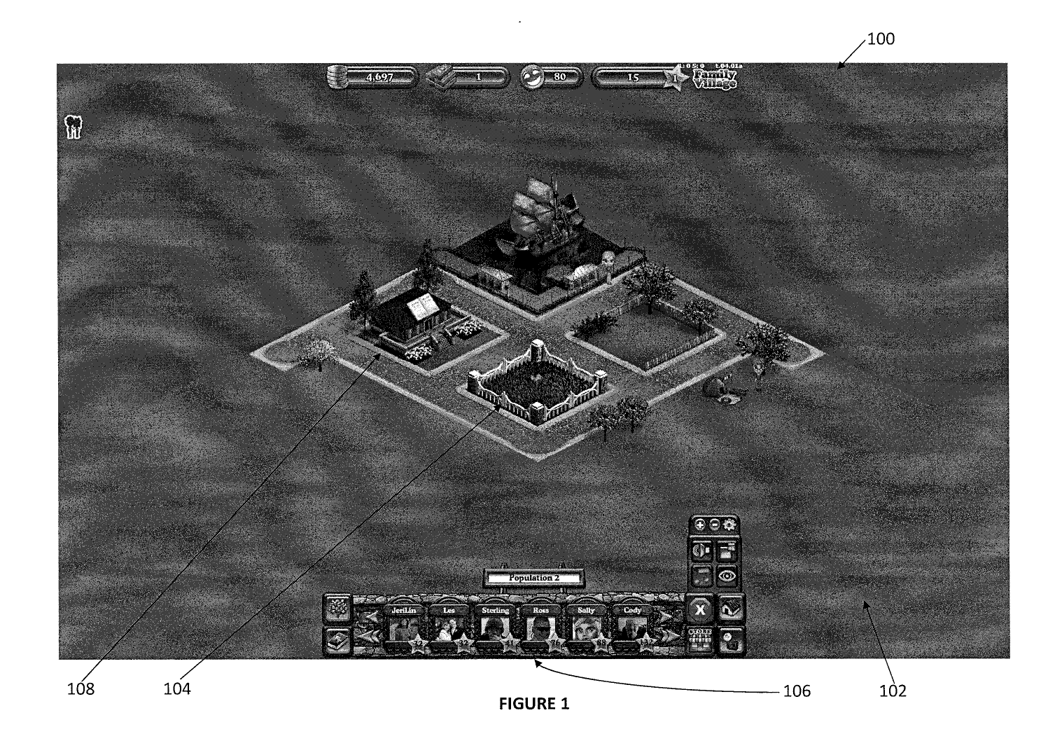

Referring to FIG. 1, in the Family Village game, the player sets up a village 100, which may include a village green 102 and a center heritage tree 104. A dashboard 106 is shown below the village 100 with controls and information that will be explained in more detail later. The player brings or “immigrates” an avatar representative of a real-life person (e.g., relative) to become a villager. The player buys a home and places the home in the village 100 for the villager to live in. Such a home may be in proximity to a library 108. The home may be purchased using coins provided to the player and accessible through the dashboard 106. The villager may also be assigned a job and put to work, a process that will described in detail later.

As the player's village 100 is being built, each avatar (villager)may begin as a poor immigrant at status 1. The villager's status may increase as he fulfills job assignments given to him by the player and as he meets other requirements. Jobs may be located in government, leisure and business buildings and workplaces. With increasing status, the villagers can be assigned nicer homes and better jobs. Typically the status of each villager can be increased by the amount of outside real-world documents and information located and purchased by the player, as discussed more below. In some embodiments, status may be increased by the amount of real-world documents and information associated with the villager that are provided to the Family Village game by the player (i.e., user-provided documents).

Morale is a measure of how happy the villagers are. Villagers may develop increased morale by having good jobs and a nice home. A villager may be the happiest when the status of the job matches the status of the villager. The morale of one or more villagers can also be increased as a player locates and purchases real-world documents about the villagers. If the villagers have high morale, they may earn bonuses at their jobs. The village 100 may also decorated by the player to increase the morale of the villagers. Monuments may also be bought by the players to provide information about the villagers' lives. The presence of monuments in the player's village 100 may increase the value of the village when neighboring villagers visit the player's village. Morale may also increased by giving gifts to the villagers.

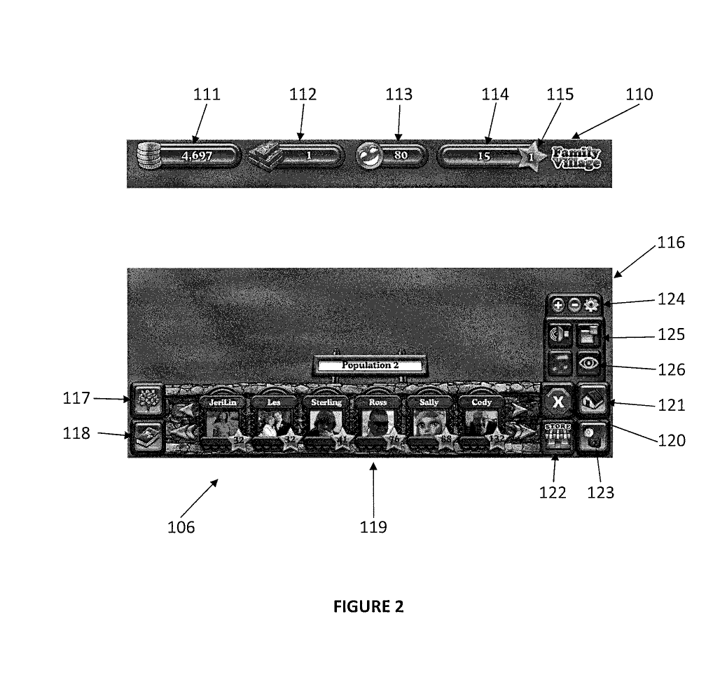

FIG. 2 shows the dashboard 106 in more detail. The dashboard 106 is the control center for the Family Village game. The upper dashboard 110 displays the player's coins 111, cash 112, morale 113, heritage points (HP) 114 and level 115. The lower dashboard 116 displays the family tree icon 117, the library icon 118, the player's (FACEBOOK®) friends who are also playing Family Village (the “neighbors”) 119, the “X” button 120 (to cancel or stop an action), the “storage and gifts” icon 121 (used to store items the player may not want to display in the village 100 right now), the “store” icon 122 and the “take a picture” icon 123 (used to take a picture of the village 100 that the player can send to the friends).

Above the X button 120 and the storage and gift icon 121 are the +, − and * icons 124. The + and − icons are used to zoom the view of the village or Family Tree in and out. The * icon may be selected to expand the lower dashboard 116. Expanding the lower dashboard 116 displays the “mute game sounds” and “toggle full screen” icons 125, and “mute music” and “display quality” icons 126.

A player can visit a neighbor by clicking the neighbor's image shown in the neighbor bar 119 of the lower dashboard 116 shown in FIG. 2. Clicking on the neighbor bar 119 may load the neighbor's village onto the player's screen. When visiting neighboring villages the player can perform several helping tasks for each neighbor each day. These tasks include recovering jobs that have expired, collecting payment for a completed job, and helping complete a job. Accomplishing each task allows the player to share in the income earned by the neighbor. The player may also invite the neighboring villager to visit the player's village.

### Family Tree Builder

The “Family Tree Builder” is a component of the Family Village game that is used to build a family tree for the player's ancestors or other individuals for whom the player seeks information. To progress further in the Family Village game, the player may add more villagers to the game. In the Family Village game, the residents of a player's village may be immigrated from the player's real ancestral family. The Family Tree Builder builds the family tree from which the player's ancestors can immigrate.

Before the player can immigrate villagers to his village they may be entered into his family tree. For the player to increase in heritage points and levels in the Family Village game and for the villagers to increase in status, the player may need to have more information about the villagers in the family tree. Such player information may be kept secure and may not be sold to parties outside of the Family Village game. Additional information about the player and his relatives, such as birth date, birth place, death date, death place, etc., allows the Family Village game to search in the background for documents possibly about the individuals the player has entered in the family tree and immigrated into his village.

The Family Tree Builder can automatically import the player's family members from a family tree provided by an external ancestral database, such as may be owned by FamilyLink. If a player is not a member of FamilyLink, then the player can key in information to the family tree using the Family Tree Builder. The information may be obtained by the player from external sources, such as a printed family tree prepared by the player or others previously, or such as an Internet data base provided by ANCESTRY.COM®.

The information input into the Family Tree Builder may include, for living family members, information such as the name, birth date, birth place, current residence and email address of the family member. For deceased family members the information input into the Family Tree Builder may include information such as the name, birth date, birth place, death date and death place of the family member.

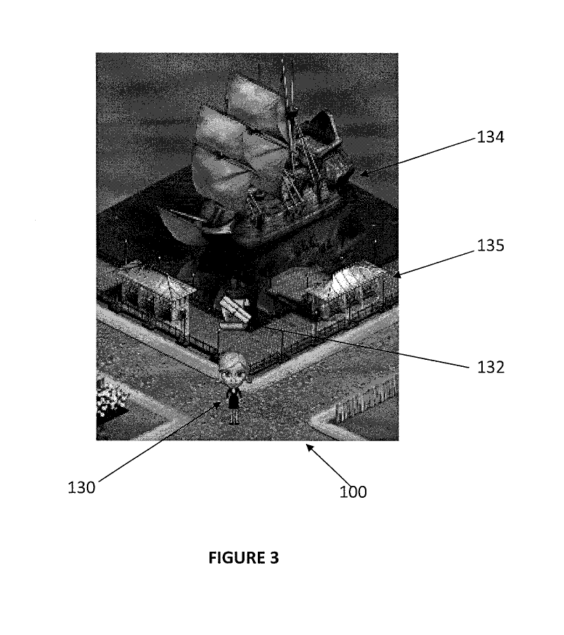

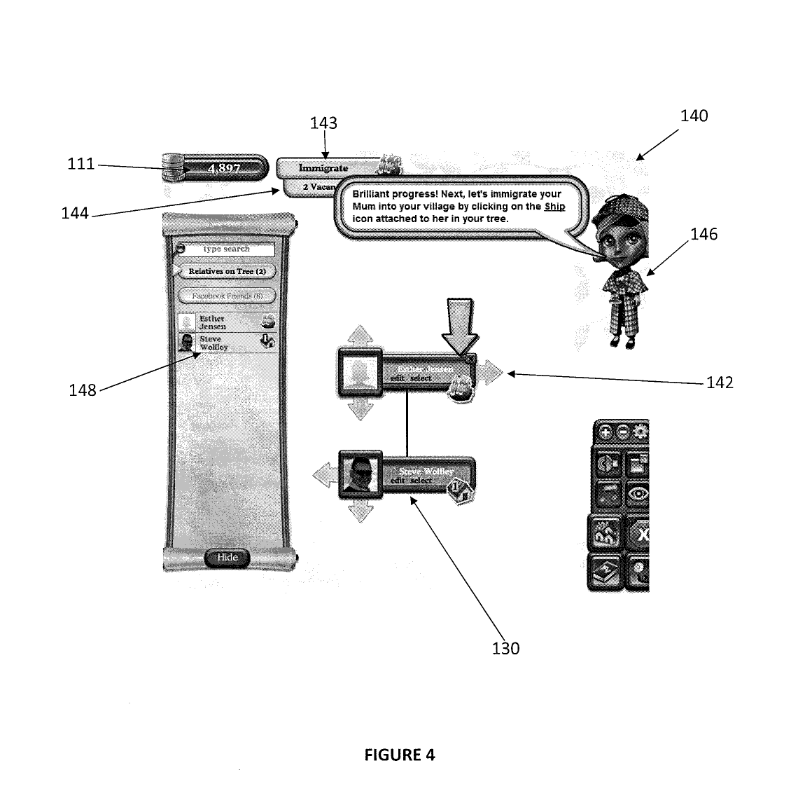

Looking now at FIG. 3, at Level 1 of the game, a player can immigrate one additional family member as a new villager 130 into the village 100 from the ship 134 at an immigration dock 135. The player may click on the family tree icon 117 shown in FIG. 2 while in the village mode to access the family tree screen 140, shown in FIG. 4. FIG. 4 shows that each new villager 130 is entered by the player, using names and data window 142 on the family tree. The immigration button 143 may then be clicked to immigrate the ancestor. Game funds from coins 111 in upper dashboard 110 shown in FIG. 2 may be required to be paid to make the ancestor a villager.

As also shown in FIG. 4, a friendly wizard 146 is provided to assist the player in editing and adding to the family tree view. An individual in a player's family tree may have one of two different icons located in his information box (not shown). These icons signify that the individual is either eligible to immigrate or signify the Status he has. A dashboard 148 in the family tree screen 140 displays the relatives on the family tree and provides many of the same functions provided by the lower dashboard 116 shown in FIG. 2.

In window 144, the number of vacancies is shown, referring to the number of openings in the player's village. The player may fill the vacancies by immigrating the family tree members into the village by entering data into window 142. The player may review a list of family members eligible for immigration and select any eligible family member. He will need to pay a predetermined amount of coins for passage and then place the new villager at the immigration dock 135 located at the top of the village plot, as shown in FIG. 3.

In building a family tree, the player first starts with information about himself. To help the player get started in the game, the Family Village game may automatically loads his pedigree with default data into the family tree when he starts playing the Family Village game. Alternatively, if he is a member of FamilyLink, his FamilyLink tree may be automatically populated into the Family Tree Builder.

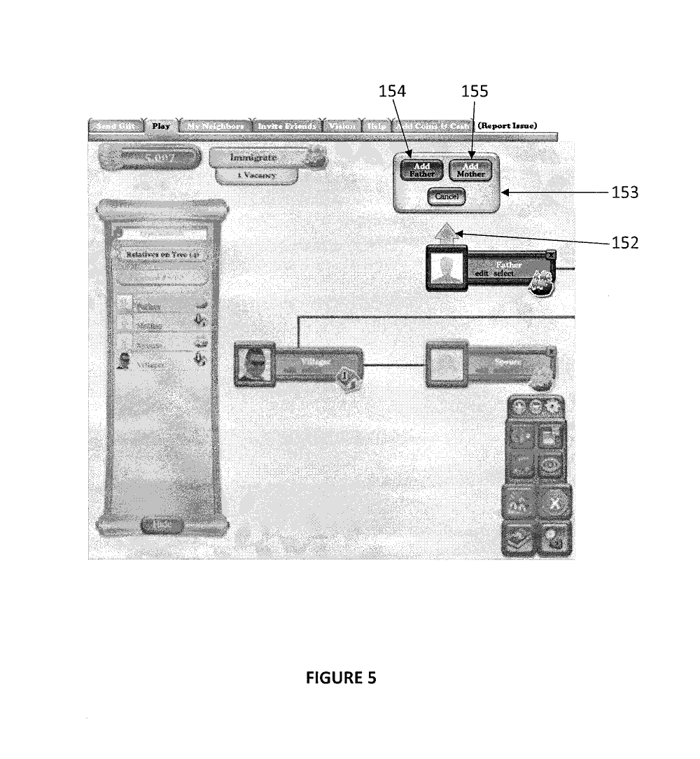

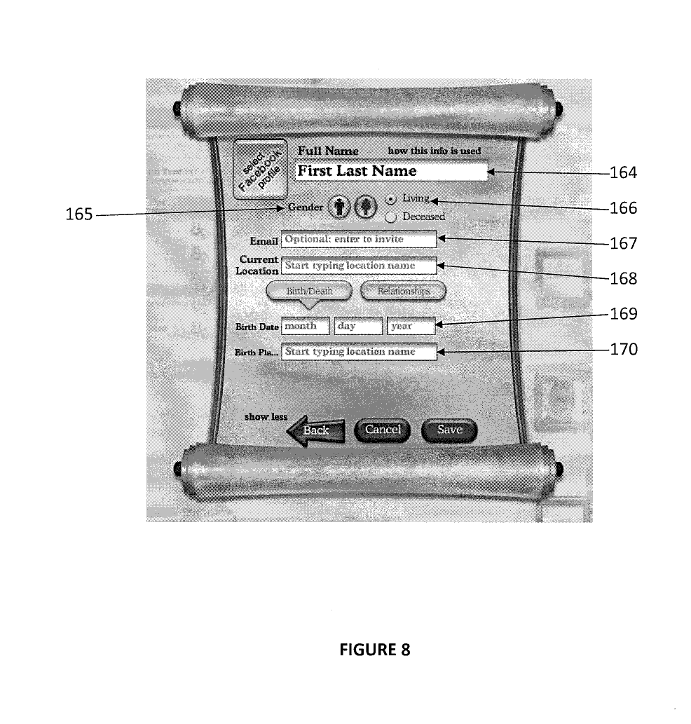

Referring to FIG. 5, to add relatives to a player's family tree, the player enters the Family Tree Builder by clicking button 117 in FIG. 2. If the player is adding a father or mother, the player clicks on an upper arrow 152 in FIG. 5, which brings up an “Add Father and Add Mother” box 153. The player selects the “Add Father” button 154 to add a father or the “Add Mother” button 155 to add a mother. The player is then taken to the individual edit screen FIG. 8.

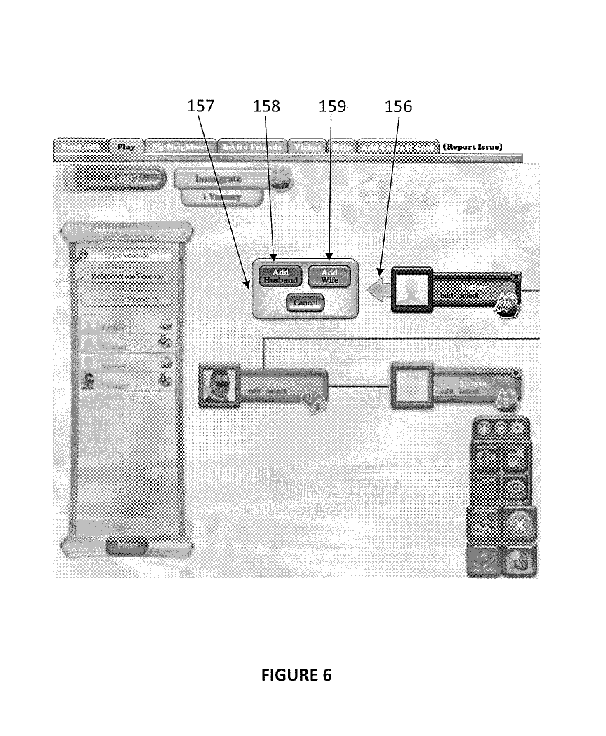

If the player is adding a spouse, the player clicks on a horizontal arrow 156 in FIG. 6, which brings up the “Add Husband and Add Wife” box 157. To add a husband, the player clicks on the “Add Husband” button 158 or to add a wife, the player clicks on the “Add Wife” button 159. The player is then taken to the individual edit screen FIG. 8.

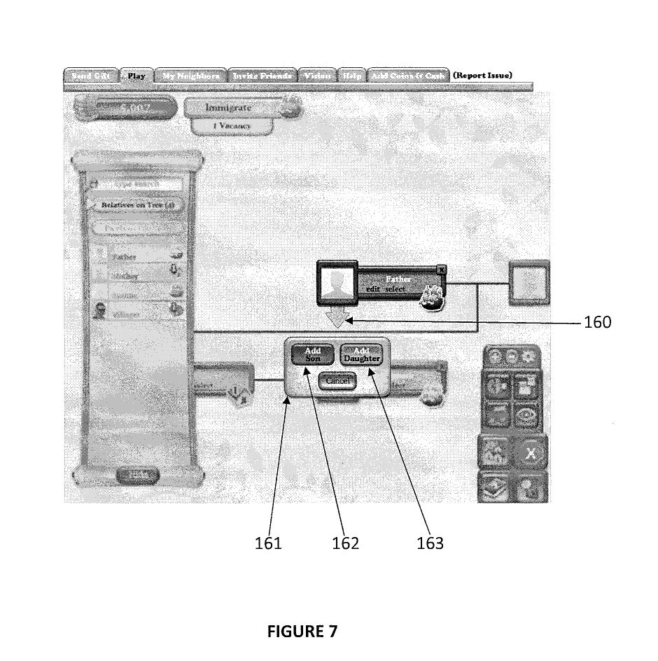

If the player is adding a child, the player clicks on a down arrow 160 in FIG. 7, which brings up the “Add Son and Add Daughter” box 161. To add a son, the player clicks on an “Add Son” button 162, or to add a daughter, the player clicks on an “Add Daughter” button 163. The player is then taken to the individual edit screen, shown in FIG. 8.

In the individual edit screen shown in FIG. 8, the player may enter or select the following information: full name 164, select gender 165, select living or deceased 166, email address 167, current location 168, birth date 169, and birth place 170. The Family Village may automatically save the changes from time to time in the Family Tree Builder.

When a villager is immigrated, the player may want to assign a job and a home for him, according to his status. Homes may be purchased using the coins and cash provided at 111 and 112 in FIG. 2. Jobs may also be assigned according to villager status and paid for by the player in coins. As each villager accomplishes his job, a pay coin may be provided above his head that is collected by the player. The player can also use the coins and cash to purchase buildings, trees, roads, monuments, and the like, to beautify the village and thereby boost the morale of the villagers, as discussed in more detail below.

As a new villager is immigrated into game play, the Family Village game may automatically perform a search in the background for the front page of a newspaper 12 corresponding to the new villager's birth date. A document icon 132 in the form of a scroll is shown above the head of the villager 130 in FIG. 3, indicating that a real-life document has been found. The player may click on the document icon 132 and be presented with the front page of a newspaper corresponding to the villager's birth date. A copy of the front page of the newspaper may be purchased by the player and placed in the villager's book in the player's library, for example, in the manner discussed below.

Typically external documents obtained from real-world search databases are paid for by a player using real funds (e.g., from a credit card, a debit card, electronic transfer of funds from a bank account, etc.). Likewise real funds may be used to purchase additional game coins and cash.

In addition, as the game progresses, the game may perform background searches, reviewing various outside real-life databases behind the scene. These databases may include the 1930 U.S. Federal Census, Find-a-Grave™ databases, and newspaper archive databases, as well government records, birth records, military records, marriage records, immigration records and foreign records, to name only a few databases.

In each search, the queries are submitted for documents or information associated with each of the villagers/family members immigrated into the Family Village. Each day a document may be presented to the player for up to five of the villagers/family members. The player may then be able to determine whether the document presented matches the villager/family member. The player may then given an opportunity to buy the copy.

### The Family Library

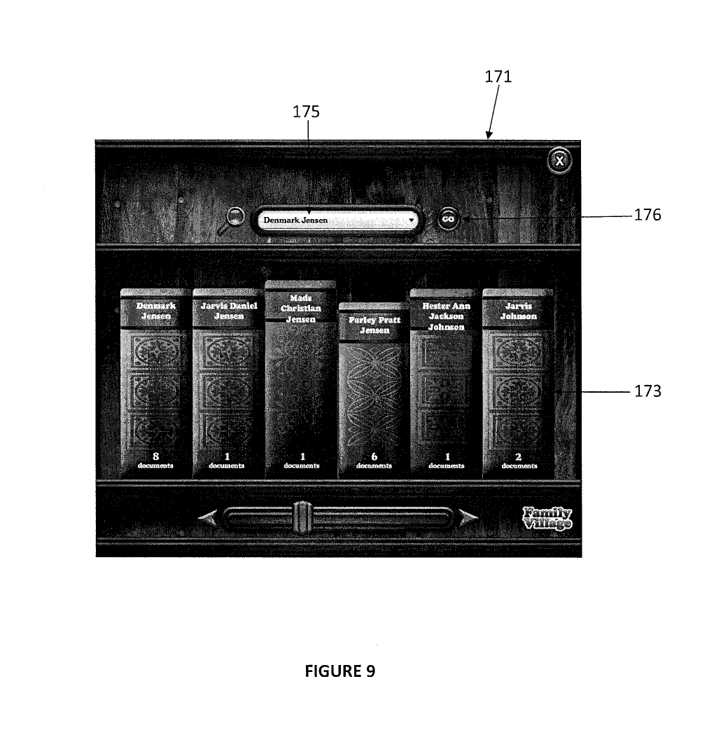

Referring next to FIG. 9, each player has a family library 171, which may include a separate book 173 for each villager 130 that has immigrated into the village 100 (FIG. 3). Each real-world document, such as newspaper copies, relating to each villager 130 that has been retrieved from outside databases is stored in the book 173 for that villager 130.

In some embodiments, real-world documents that are user provided may also be stored in the book 173 for the associated villager. Such user-provided content may be uploaded by the player operating the village 100, or by other players of the Family Village game, such that the user-provided documents may be stored in an internal database of the Family Village game that is accessible by other players. Thus, the Family Village game may be configured to receive user-provided content. “User provided” is intended to indicate that the content is provided by a player of the Family Village game as opposed to some other external source.

User-provided content may be original content that originated with the player, such as photographs taken by the player and uploaded to the Family Village game. User-provided content may also include content that originated with others, but that the player has possession of, or other access to. For example, user-generated content may include documents that the player received from some other source or person, but that the player uploaded the document to the Family Village game. Thus, user-provided content may include various real-world documents uploaded to the Family Village game by a player. For example, real-world documents may include images, such as photos or scans of real-world documents. Such images may be configured according to various formats and file types, including .jpg, .gif, .png, .pdf, etc. Photos may include original photos (or scanned photos) of the a player, villager, or family member or photos of items related to such persons (e.g., headstone). Other photos may include photos of marriage certificates, death certificates, or other official or related documents (e.g., newspaper articles). Real-world documents may also include journals and other writings written by the player, the villager, or other family member. Such documents may also be scanned and formatted as an image file. Some documents may already be written in an electronic format, such as a Word document, or PDF. Real-world documents may further include audio files and video files associated with the player, the villager, or other family member. Other user-provided content is contemplated as being any type of real-world source information dealing with any person associated with the Family Village game.

Once such user-provided content is uploaded to the Family Village game, such user-provided content may be available to the player that uploaded the content. In addition, the user-provided content may also be available to other players of the Family Village game who are linked (e.g., FACEBOOK® friends, established family members, etc.) to the player who uploaded the content. In additional embodiments, such content may be made available to other players in the Family Village game who are unlinked to the player who uploaded the content. For example, such unlinked players may be persons who the original player is unaware of (or may not even know), but who may have an interest in obtaining more information related to the villager to whom the user-provided content is associated with. For example, the unlinked player may be a person who shares the villager as a relative. In some embodiments, linked and/or unlinked players may need to pay a fee in order to access such content. In some embodiments, the player may be given the decision as to the sharing settings for user-provided content when uploaded. For example, the player may choose to share some user-provided content with linked players only, and other user-provided content with all players of the Family Village game, or not share at all. Players may be offered incentives to encourage sharing user-provided content. An example of uploading user-provided content is described further below with reference to FIGS. 22 through 28.

At any time during the game, the player may go the family library 171 screen and perform specific, direct searches for documents for a specific villager/family member. The family library 171 provides a place to store the documents that the player has found for each villager 130, and it is a place to search and locate those documents for a villager 130 later in the game.

To search for new documents, the player may use the dropdown menu 175 in the main family library 171 screen to select the villager 130 that he would like to search for. Then the player may click a “Go” button 176 to initiate a search. Such searches may be performed from external databases. Searches may also be performed from internal databases containing user-provided documents. In some embodiments, the player may select which type of database may be used for a particular search, or if all available databases are to be searched.

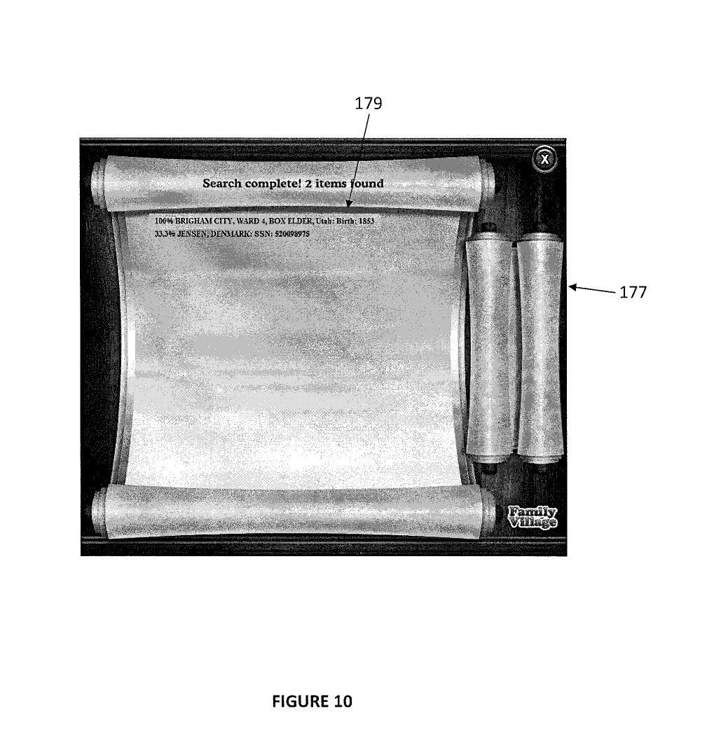

Referring to FIG. 10, the results of the search are displayed in a search results screen 177 showing search result items 179. The player can click on each search results item 179, which is a possible record of the villager 130 being searched, to obtain more detailed information.

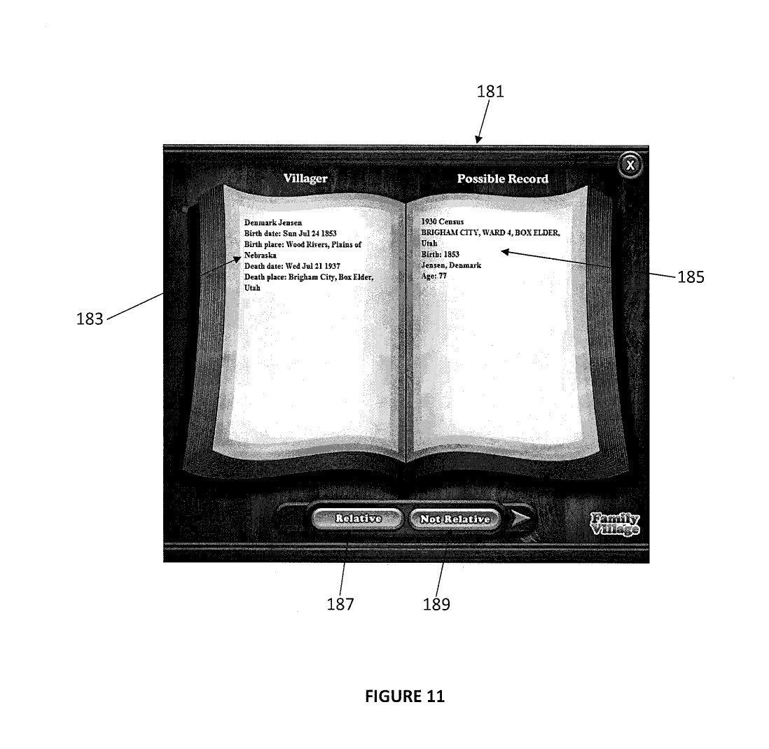

By clicking on each search results item 179, the player is taken to a comparison screen 181, shown in FIG. 11, where he can compare the search results data 185 associated with search results item 179 (taken from a located record) to the family tree information 183 regarding the villager 130. If the search results data 185 correlates with the family tree information 183, then it is likely that the related document is about the player's relative, and the player can click a “Relative” button 187. If the search results data 185 does not correlate with the family tree data 183, then the related document is less likely to be about the player's relative, and he may click a “Not Relative” button 189, so that the located document associated with the search results data 185 will be removed from the player's search results. Then, the data from the next Possible Record, if any, (not shown) will be displayed on the comparison screen 181.

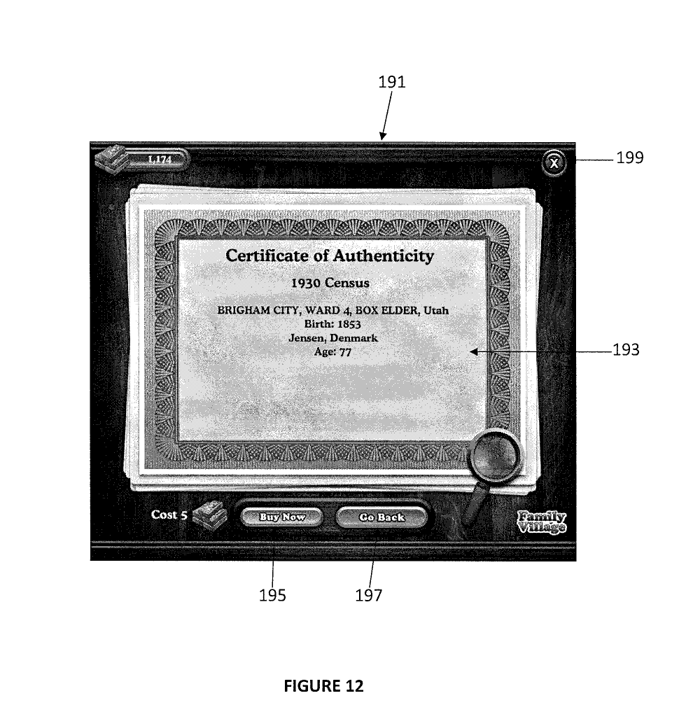

If the player selects the Relative button 187, he will be taken to a preview screen 191, shown in FIG. 12. There, the player may view an entire document 193 (such as a census certificate) associated with the search results data 183. The Preview screen 191 shows a more detailed description of the document 193 and gives the player the option to purchase the document. If the player selects a “Buy Now” button 195, the document 193 will be stored in villager's 130 book 173 shown in the family library 171 in FIG. 9. If the player selects the Go Back button 197 he will be taken back to the previous screen. If the player wants to return to the search screen, he can click on a “Cancel” button 199.

In addition to player-initiated searches, the Family Village game may periodically search for documents relating to the player's family members. Such searches may be performed from external databases. Searches may also be performed from internal databases containing user-provided documents. These searches are performed in the background and do not affect game play. If a suitable match is found, a document icon 132 will appear over the head of one or more of the villagers 173, as shown in FIG. 3.

Because of duplicate names in family history databases, not all documents that Family Village finds in a search for a villager 130 will actually be about that particular villager 130. To see if the document is actually about an ancestor, the player will click on the document icon 132 above the head of villager 130 in FIG. 3. This action opens the document preview screen 180 shown in FIG. 10. If it appears that there is a match with the player's ancestor, he can choose to purchase the document for his villager 130. Buying a document for a villager 130 will substantially increase his morale, as discussed below.

### Flow Diagrams for Searching External Databases

As stated above, searching external databases can be initiated either by the player generating a query or by the Family Village game automatically generating a query at various points in the game. In either case, the following sequence occurs: (1) a query is sent to an external database server containing an instruction, (2) the server receives the query and determines which real-world documents and information meet the criteria of the query, and the (3) server presents the new information and documents to the game for display, comparison, selection and ongoing availability.

For each villager for which a query is created, a number of elements are considered in crafting a query that will return hits relating to that specific individual. With a person's birth date, searches are performed from the birth date forward in time. Inclusion of specific locations where the individual has lived helps narrow the search.

Some databases would not be searched if such a search is illogical. For example, if a villager was not born before 1930, or if he died before 1930, then a query would not be sent to the 1930 U.S. Federal Census database.

After a query has been sent to a server and results have been received by the game, the results are examined and prioritized according to the information known about the villager. If the query results in no results, another query based on less detailed criteria is sent to the server. If the query results in too many hits, then a refined query is sent with more detailed criteria. For example, if the villager has a common name, then more details may be required to narrow down the search.

When the result of a query has a manageable number of potential documents and information, then each piece of information is compared to the data already known about the villager and is given a rating based on that comparison. Each new piece of information is added to a list, sorted from the highest match rating to the lowest, and is presented to the player.

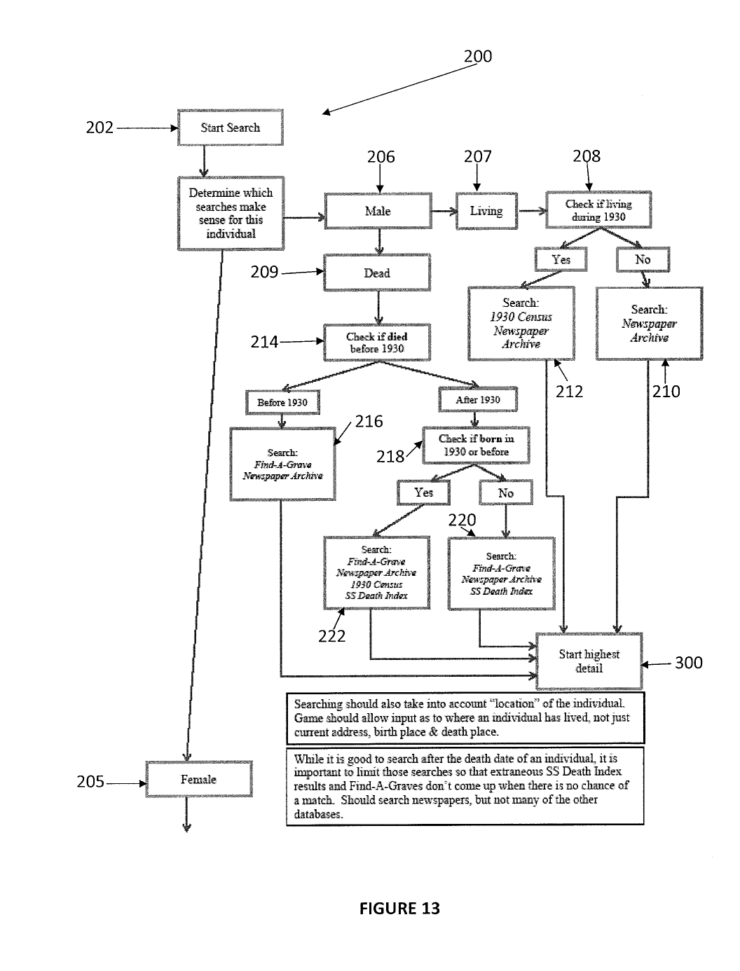

Looking now at FIG. 13, a flow diagram is provided showing an implementation of a search 200 for information about a villager according to the present disclosure. Where possible, queries should include as much background information as available to help in focusing the search. For example, the birth date, death date (if any), birth and death locations and locations where the individual may have lived may all be helpful in the search.

At “Start Search” 202, a query is submitted with the above background information, and a preliminary determination is made at reference 204 to determine whether the individual is male or female. If the individual is a female, then the search branches to the female search 205 to be described below. If the individual is male, then a determination is made at reference 206 as to whether the person is living or dead based on information submitted in the search. If the person is living, as provided at reference 207, a determination is made at reference 208 as to whether the person was living during 1930. If not, then searcher bypasses ancestral databases, and a search of one or more other databases, such as the Newspaper Archives database, is made at reference 210. If the individual was living during 1930, then searches of the 1930 U.S. Federal Census database and at least one other database, such as the Newspaper Archives, are made at reference 212. In either event, the search then carries forward to a highest detail review 300 discussed below. Other external databases may also be searched. For example, the recently released 1940 U.S. Federal Census database may be searched if the individual was living during 1940. Thus, the description herein related to the 1930 U.S. Federal Census may likewise be applied to the 1940 U.S. Federal Census, or other similar databases.

In the event that the individual is now dead, as provided at reference 209, then a determination is made at reference 214 as to whether he died before 1930. If he died before 1930, then he would not have appeared in the 1930 U.S. Federal Census, and the search branches to reference 216 to search one or more databases that may provide information about a person who deceased before 1930, such as the Find-a-Grave and Newspaper Archive databases. The search then carries forward to the highest detail review 300 discussed below.

In the event that the individual died after 1930, then a determination is made at reference 218 as to whether the individual was born in 1930 or before that time. If not, then the person would not be found in the 1930 U.S. Federal Census, and a search is made at reference 220 for at least one other database, such as the Find-a-Grave database, the Newspaper Archives, and/or the U.S. Social Security Death Index. If the person was born in 1930 or before that time, then in addition to the searches performed at reference 220, the search also includes a search of the 1930 U.S. Federal Census database, as shown at reference 222.

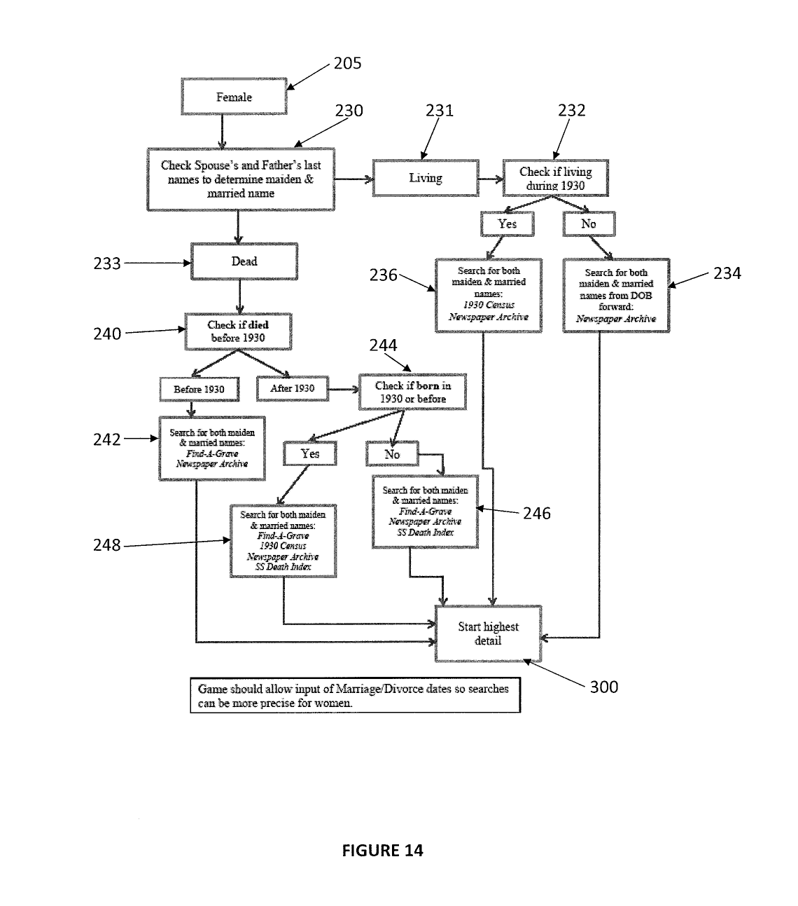

Referring next to FIG. 14, a search flow diagram is shown for females, beginning at reference 205. At reference 230, a determination is made of the woman's maiden name and married name from the data provided about the woman's spouse and father. If the woman is living, as provided at reference 231, then a determination is made at reference 232 as to whether the person was living during 1930. If not, then searcher bypasses ancestral databases, and a search is made at reference 234 of at least one other database, such as the Newspaper Archives database, looking for the woman's maiden and married names. If the woman was living during 1930, then a search is made at reference 236 of the 1930 U.S. Federal Census database, as well as of other sources, such as the Newspaper Archives. In either event, the search then carries forward to a highest detail review 300, discussed below.

In the event that the woman is now dead, as provided at reference 233, then a determination is made at reference 240 as to whether she died before 1930. If she did, then she would not have appeared in the 1930 U.S. Federal Census, and the search branches to reference 242 to search one or more databases that may provide information about the deceased person, such as the Find-a-Grave database, the Newspaper Archives, and/or the U.S. Social Security Death Index. The search then carries forward to the highest detail review 300, discussed below.

In the event that the woman died after 1930, then a determination is made at reference 244 as to whether the woman was born in 1930 or before that time. If not, then she would not be found in the 1930 U.S. Federal Census, and a search is made at reference 246 of at least one other database, such as the Find-a-Grave™ database, the Newspaper Archives, and/or the U.S. Social Security Death Index, using both her maiden and married names. If the woman was born in 1930 or before that time, then in addition to the searches performed at reference 246, another search also includes a search of the 1930 U.S. Federal Census database, as shown at reference 248. The search then moves onto the highest detail review 300. Note that the game will also allow for input of marriage and divorce dates, so that female searches may be more precise.

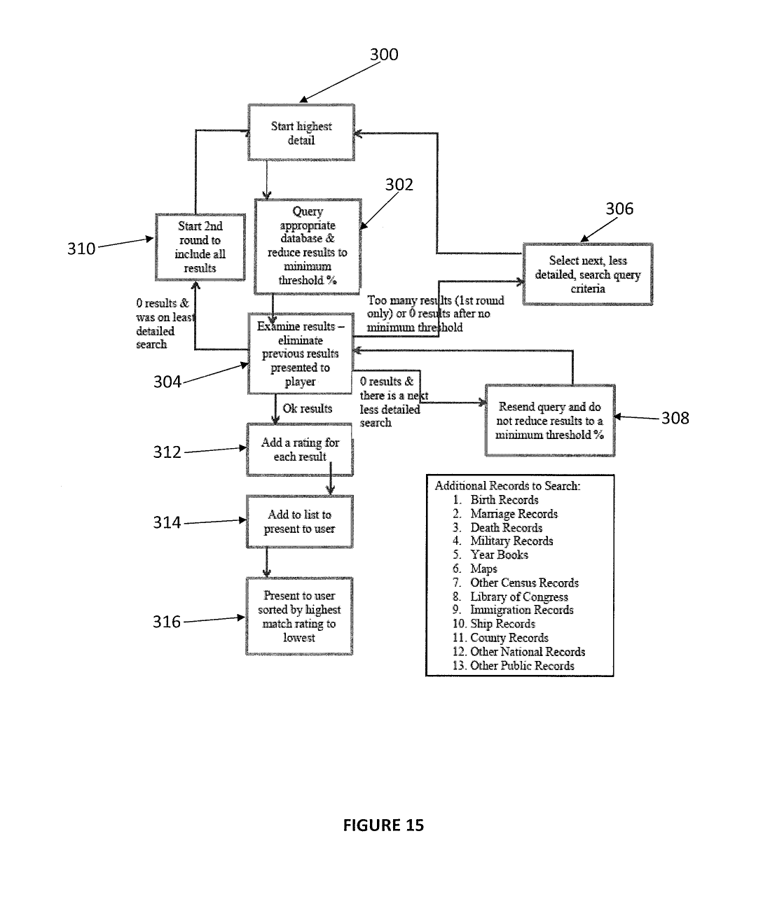

Referring now to FIG. 15, the query search is shown for the highest detail search 300. It should be understood that each search query may vary in detail from the least amount of detail (perhaps just the individual's name) to a very high amount of detail (that may include birth and death dates and locations, names of spouse and parents, etc.). Typically, a player would initially want to start with a query having the most or highest detail possible to determine which results might correspond to all the available data. If no results are obtained, then fewer details would be provided in the next search query to broaden out the search, so as to try to obtain some results.

Also, in the database searches, each result is rated at a percentage of similarity to the data included in the query. If there is complete correspondence between the query data and the search result, then the result data is rated at 100%. If there is no correspondence between the query data and the search result, then the result data is rated at 0%. Other results that show some correspondence to the query data may be rated between 1% and 99%, depending on the degree of similarity to query data. Typically, a search would include a threshold percentage that would drop all results below that percentage.

At reference 302, the greatest amount, highest amount or most detail is provided in the initial query that is presented to the desired database, and all results produced that are above a minimum percentage threshold are provided. At reference 304, the results are examined and any results from a prior search are eliminated. At reference 306, if there are no results and there was no minimum threshold, or if there were too many results (after the first round), then a less detailed search query is presented to the initial search reference 300.

If there were no results and there is a next, less detailed search query, then, at reference 308, the less detailed query is sent with the minimum threshold requirement to obtain the search results to reference 304. If there were no results and the least detailed search had been performed, then, at reference 310, the second round of search query would be provided with no minimum threshold.

At reference 304, if the number of results is manageable, then at reference 312 a rating is applied to each result, depending on its correspondence to the data in the search query. This rated search result is then added to a list to present to the player at reference 314. At reference 316, the list is presented to the player, in which the search results are all sorted from the highest rating to the lowest rating.

### Other Aspects of the Game

### Buying a Home

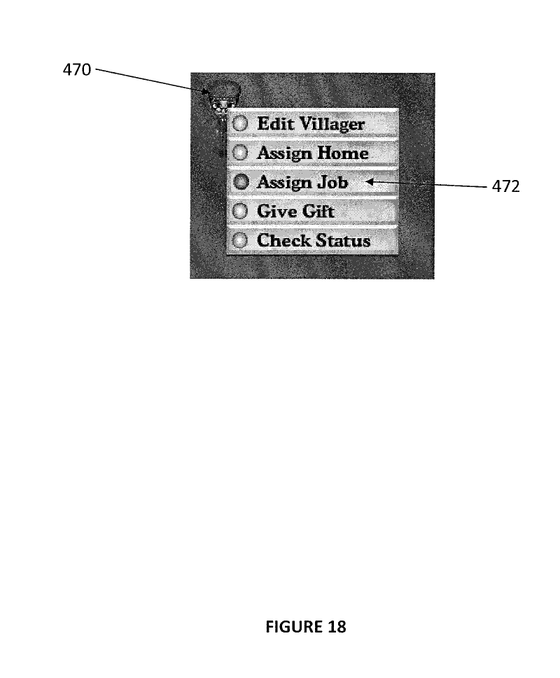

After a villager 130 has been selected from the family tree and immigrated into the village, the new resident will be waiting for the player at the immigration dock 135 shown in FIG. 3. The player may want to provide the villager 130 with a home and a job as soon as possible. The player can assign the villager 130 a home by clicking and dragging the villager 130 onto a home or by clicking on the villager 130 and selecting “assign home” from the dropdown menu, as seen in FIG. 18.

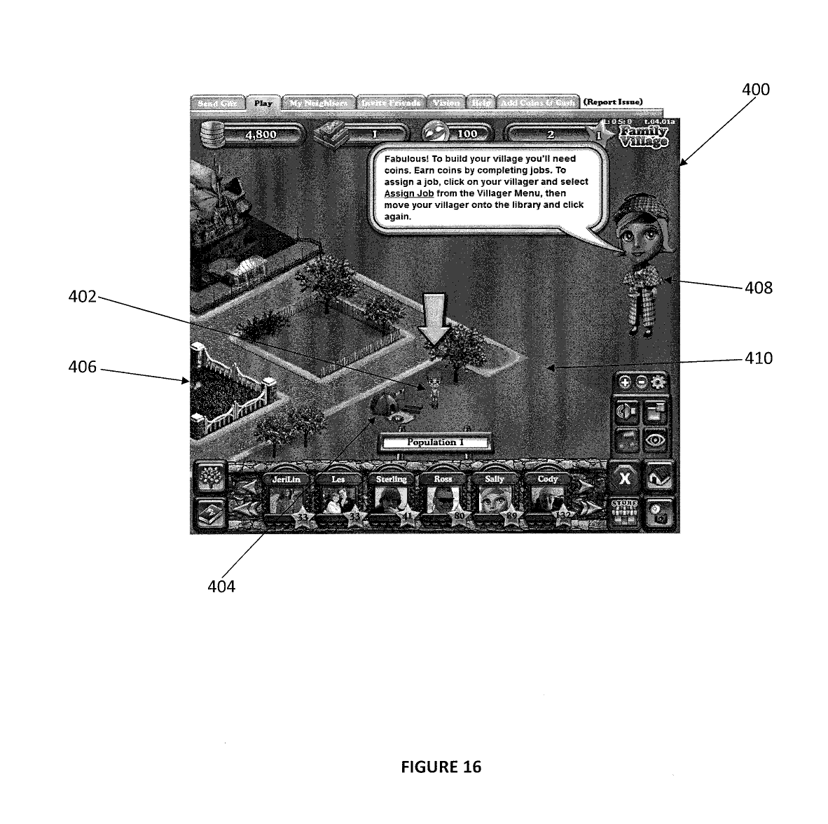

Looking at FIG. 16, another view of a village 400 is shown. A villager 402 is positioned next to his new home 404 near a village center 406. A friendly wizard 408 stands on the side of a playing field 410 to provide directions of how to put the villager 402 to work.

When a home 404 is selected, an indicator will whether or not the villager 402 can reside there. A villager 402 can live in a home 404 that is at his status or lower. However, if the player assigns a villager 402 to live in a lower status home 404, the villager's 402 morale may degrade every day. If the villager 402 is assigned to an appropriate status home, his morale may maintain its current daily level, as discussed in more detail below.

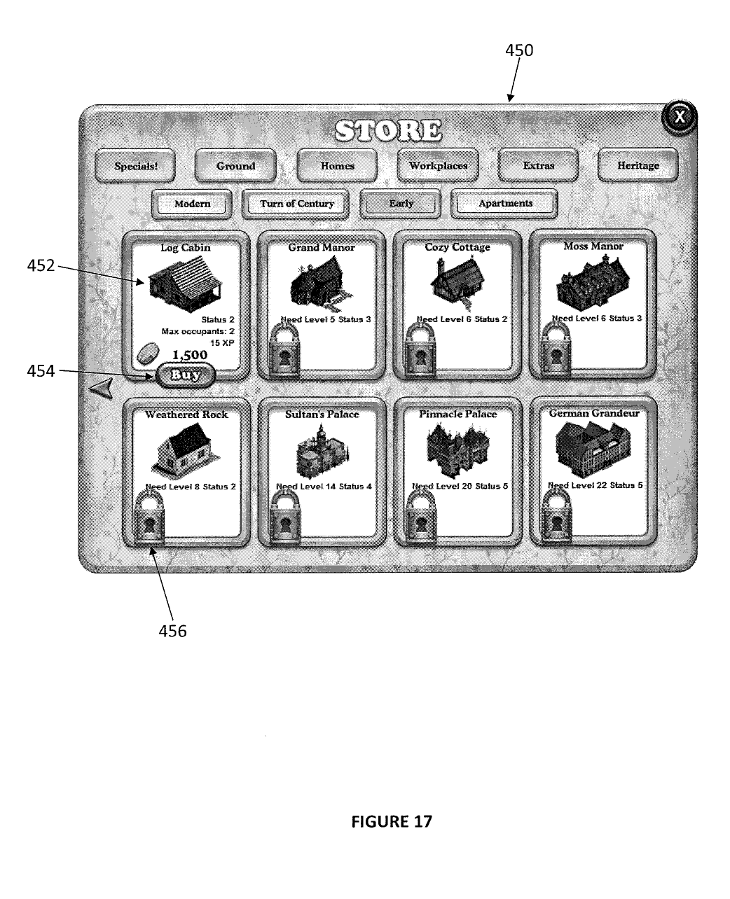

To buy a home 404, the player may click on the store icon shown in FIG. 2 (the icon with a store front) located on the lower dashboard 116. This action will take the player to a store screen 450 shown in FIG. 17. There, the player may select a home 452 he would like to purchase by clicking the corresponding “Buy” button 454. Some of the homes 452 have locks 456 that can only be unlocked in the manner described below.

After selecting the home 452, the store screen 450 will close and the village 400 (e.g., as shown in FIG. 16, etc.) will reappear. The player may move the home 404 to the desired location and can rotate the home 404 by clicking on the home 404 and moving it to the desired orientation. The player will then place the villager 402 in the home 404.

With returned reference to FIG. 17, there are two requirements for unlocking homes 452: (1) Status Unlock: The player may need to have at least one villager 404 (FIG. 16) with a sufficient status to occupy the home 452 to unlock that home 452; and (2) Time Period Unlock: The player may need to have at least one villager 404 born in the time period in which that type of home 452 was built; for example, to unlock an Early home 452, the player may purchase the home 452 on behalf of at least one villager 404 born before 1870. There are three time periods for homes 452: (1) Early: before 1870; (2) Turn of century: 1870 to 1930; and (3) Modern: after 1930.

In some embodiments, for homes 452 that must be purchased with coins, a maximum number (e.g., two) of villagers 404 may be set for living in the same home 452. For homes 452 that must be purchased with cash the Family Village game may allow additional villagers 402 living in the same home 452. The number of residents that can occupy each home is listed in the store.

### Assigning a Job

As shown in FIG. 18, the player can click on a villager 470 and select “Assign Job” in the dropdown menu 472. Alternately, a player can assign a villager 470 a job by clicking and dragging the villager 470 onto a building. Using either method, the selected building color outline may initiate and indicate whether or not the villager 470 can work there.

Villagers 470 can work in jobs that are at or below their status. If the player assigns a villager 470 to a job below his status, the villager 470 will be unhappy and his morale may degrade. The best strategy is to assign a villager 470 to a job at his status. The villagers 470 may work as independent contractors. For every job they are assigned they may be required to pay for their own insurance and taxes. The costs of these expenses may be deducted at the beginning of the job.

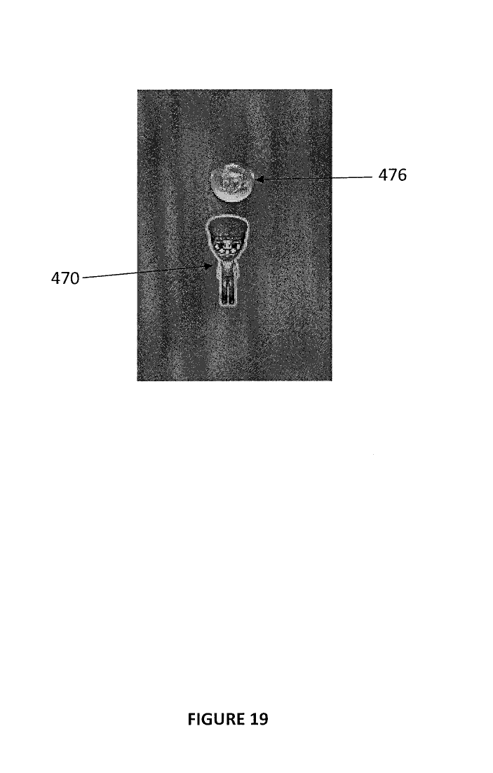

As shown in FIG. 19, once a villager 470 has completed his assigned job, he will have an indication that he is done and a coin 476 may float above his head, meaning that the player can collect that villager's 470 wages. The player will have a window of time to collect the villager's 470 wages that is equal to twice the duration of the job. The player collects wages by clicking on the coin 476 above the villager's 470head. The player should make sure to return to collect the villager's 470 wages when that villager's 470 work shift is done. Otherwise, the villager 470 might spend his paycheck on some frivolous activity, such as a night out on the town or a road trip.

If a villager 470 has a coin 476 with an X mark through it, the player did not collect the villager's wages in time. If the player clicks on the coin with an X mark, the job expires and the player will not collect any coins on behalf of that villager 470. However, neighbors who visit the village may be able to recover the expired job. Rather than letting that job and its wages go to waste, the player may ask the neighbors to recover the job for the villager 470.

Strategy for Assigning Jobs

The strategy for assigning jobs will most likely be determined by the player's personal schedule but, in general, there are five elements to consider when choosing the game play strategy: (1) Assign jobs that are of equal status with that of each villager to prevent his morale from degrading. Happy workers may earn a bonus in their jobs (e.g., up to 30%, etc.) which can increase morale (e.g., up to 90%); (2) Assign jobs that will mature by the time the player logs in again. If the player fails to collect the wages of a villager before his job expires, the villager may spend his money; (3) Shorter jobs yield more experience and coins per minute than long duration jobs; (4) Jobs assigned in buildings that were purchased using cash have a bonus (e.g., a 30% bonus, etc.) associated with them; (5) The player may also gain heritage points when the player purchases certain items from the store.

### Obtaining and Spending Coins and Cash

The coin count and the cash count are both located at the top left corner of the upper dashboard 110 shown in FIG. 2. There are three ways to increase the number of coins the player has: (1) complete a job and collect the wages; (2) visit a neighbor and complete a helping task; and (3) purchase more coins on the “Add Coins & Cash” tab.

There may be three ways to increase the amount of cash the player has: (1) Increase on level in the game and the player will receive one cash bill per level; (2) Purchase more cash on the Add Cash & Coins tab using real-life funds, such a credit card; or (3) Purchase more cash on the Add Cash & Coins tab using credits(e.g. FACEBOOK® credits, etc.).

The player can spend coins in the store for most basic items. He will also need coins to pay the cost of passage when immigrating villagers and when assigning jobs, so he should keep a good supply of coins available at all times. Cash can only be purchased or earned and cannot be bought with coins. If the player ever runs low on cash, the player can purchase it by going to the add Coins & Cash tab just above the game and using his credit card.

### Making Purchases From the Store

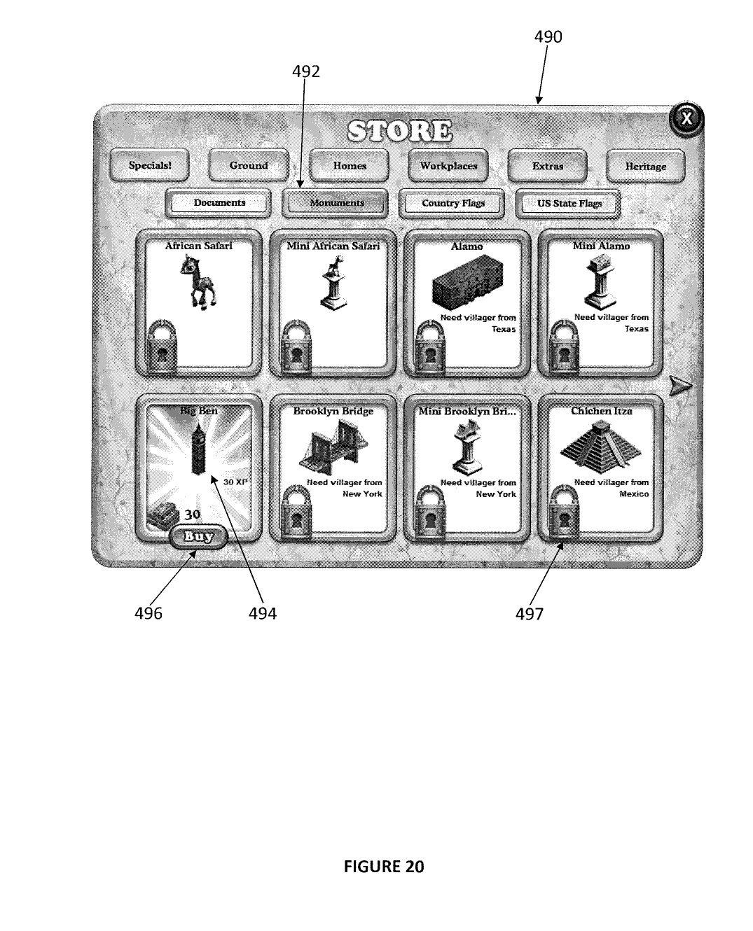

Looking at FIG. 20, the monument purchase part of the store screen 490 is shown. To purchase items in the Store, the player may first open the store screen 490 by clicking the storefront icon 122 on the lower dashboard 116 shown in FIG. 2. Then he may select the monuments button 492 and purchase the desired monument 494 by clicking the buy button 496. Some items in the store have a lock 497 and cannot be purchased until they are unlocked. These items have their unlock criteria listed in the item description window. The player unlocks the buildings according to the player's level.

Items may be purchased with either coins or cash. Coins are earned in the game by performing jobs. Cash is earned slowly by increasing the player level or can also be purchased using real currency.

The player can preview items in full size on the game board prior to finalizing purchase. Any purchase the player makes will not be final until the player actually clicks and places it within the village. Selecting the red X button 120 on the lower dashboard 116 (FIG. 2) will cancel the purchase. Clicking on the game board will complete the purchase and place the item at the location where the player clicked. Some items, like roads and plants, will allow the player to purchase more than one of that item at a time. For these items, when the player has finished the purchase, he will click on the red X button 120 located on the lower dashboard 116, which may stop all current action.

Purchasing items from the store not only increases the standard of living for the villagers, but can also increase their morale. Villagers with higher morale earn employment bonuses every time they complete a job, so that the player progresses faster. If one of the villagers is feeling sad, the player may give him a gift to brighten his day. Heritage monuments increase the villagers' sense of community and identity, as well as the morale of the village. Buildings give the villagers more options for jobs. Homes offer places to live. The player may beautify the village by building it the way that will maximize the morale of the individual villagers and of the entire village.

Premium items are items in the store that give special bonuses to the player in the form of coins, morale or heritage points. Premium items are purchased with cash. Decorations may also be purchased to increase morale. Such decorations include trees, flowers, paths, fences, parks, vehicles and animals.

Monuments are a way of honoring the best of each culture the family is connected to. Whenever the player immigrates a new villager with the birthplace, death place, and/or current residence filled in, the player may unlock a monument that the player can place in the village to show off the heritage. Purchasing a monument will also boost the morale of the village.

As the player accumulates monuments, he can collect coins from the neighbors' visiting villagers. State and country monuments are unlocked in the store when the player has at least one villager that was born, died, or currently lives in that location. Purchasing a monument will increase the morale of the village. Additionally, the number of coins the player collects from visiting villagers increases with each monument purchased.

### Villager and Village Status

As indicated previously herein, each villager has an individual status. When first immigrated, a villager starts with status 1. Over time, his status can increase to status 5. With increasing status, the player can assign the villagers higher paying jobs and nicer homes. As the player moves a cursor over a villager, that villager's status will be displayed along with additional information. In addition to individual status of each villager, there are 5status levels in each village.

For a villager to gain individual status, he may meet certain requirements. For example, he may be required to perform jobs in the village and become a documented citizen. Documentation requirements may be different for living and deceased relatives.

Villagers represent the real-world ancestors of the player. Therefore, the documentation requirements include the need for the player to connect with the living relatives in the real world or document the deceased relatives with real-world documents. The player can play Family Village without this effort, but to gain higher status levels, the player needs to engage the real family. The game provides a mechanism for the player to “buyout” of job requirements. This provision is put in place to allow players to have family members in the village who for whatever reason do not have email addresses or not members of a social network (e.g., FACEBOOK®, etc.), e.g., younger family members, etc.

| | | Living Relative | Deceased Relative |
|---|---|---|---|
| Status | Job Requirements | Requirements | Requirements |
| 1 | N/A | None | None |
| 2 | Work 4 Status 1 jobs | Name, Birthplace, Birth | Name, Birthplace, Birth |
| | (Buyout is 10 cash) | date | date |
| | | (Buyout is 10 cash) | (Buyout is 10 cash) |
| 3 | Work 8 Status 2 jobs | Relative agrees she has this | 4 ancestors of this person on |
| | (Buyout is 12 cash) | relationship with player | the Family Tree. |
| | | (Buyout is 12 cash) | (Buyout is 12 cash) |
| 4 | Work 9 Status 3 jobs | Relative is a Family | Person exists in a primary |
| | (Buyout is 15 cash) | Village Player | source, e.g., 1930 U.S. |
| | | (Buyout is 15 cash) | Federal Census. |
| | | | (Buyout is 15 cash) |
| 5 | Work 10 Status 4 | Relative is at least Level | 10 ancestors of this person |
| | jobs | 20 | on the Family Tree. (Buy |
| | (Buyout is 20 cash) | (Buyout is 20 cash) | out is 20 cash) |

For a relative to agree that he has a relationship with the player, the player may send a request to the relative through Family Village. This request can be in the form of a (FACEBOOK®) post or an email. The relative may agree that he is related to the player as outlined in the Family Tree for the villager to gain appropriate status in the village.

Searches for documents from the 1930 U.S. Federal Census and the U.S. Social Security Death Index can be done directly in the library or may be done in the background by the game.

### Villager's and Village Morale

The morale indicator 113 is located at the top of the screen in the upper Dashboard 110 between the cash count and HP indicator 114, as shown in FIG. 2. Morale is a measure of the happiness and productivity of each of the villagers. If a villager feels neglected his morale will decrease. The morale of the entire village is a sum of the morale of all the villagers in the village. The player can see the village's Morale score as a whole by looking at the morale icon at the top of the game screen. The player can see the morale of each villager by positioning the cursor over him.

To increase an individual villager's morale, the player can: (1) keep the villager employed in a job of appropriate status; (2) keep the villager in a home that is equal to his Status; (3) upgrade the villager's home; (4) buy the villager a document; and/or (5) buy the villager a gift from the Store.

To increase the morale of all the villagers in the village, a player can: (1) add buildings; (2) add monuments; (3) add decorations; and/or (4) water the Family Tree. All these activities may improve the morale of the village and of all of the villagers. Making sure that each villagers has a job and a home appropriate for their status will maintain that villager's morale at its current level. The morale of an unemployed or homeless villager will drop every day.

As discussed previously, when a villager has high morale, he will receive increased payment for each job he performs. High morale can yield an employment bonus (e.g., up to 30%, etc.) for a villager.

### Hardware Environment

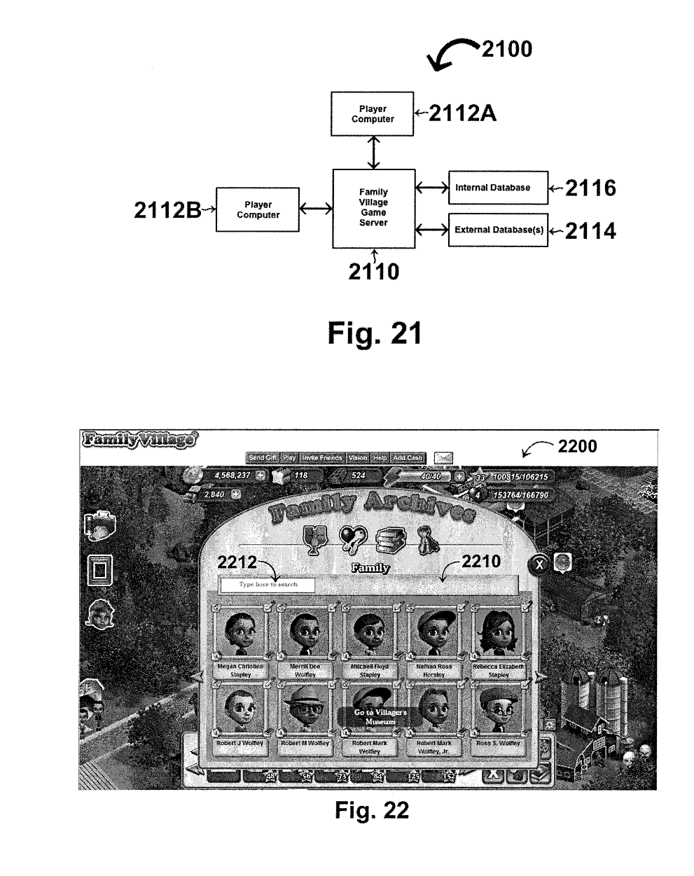

FIG. 21 is an online family history gaming network 2100 according to an embodiment of the present disclosure. The family history gaming network 2100 includes a family village game server 2110. The family village game server 2110 may include one or more processors and associated computer readable media that are configured to run the Family Village game described herein. For example, a computer readable medium may have instructions stored thereon that, when executed, cause the processor to communicate with one or more player computers 2112A, 2112B, etc. to enable players to play the Family Village game. For example, the players computers 2112A, 2112B may communicate with the family village game server 2110 over a network, such as the Internet.

The family village game server 2110 may also communicate with external databases 2114 and internal databases 2116 as described herein. For example, the external databases may include databases such as, U.S. Federal Census databases, Find-a-Grave™ databases, and newspaper archive databases, as well government records, birth records, military records, marriage records, immigration records and foreign records, and other similar databases external to the Family Village game.

The internal database 2116 may include and maintain information related to the players (e.g., name, address, birth date, email, etc.), to family members of the players, and their relationships to each other (e.g., a family tree). Such family members may be introduced into the Family Village game as villagers of the same village as the player. The internal database 2116 may also organize and store user-provided content received from the various players of the Family Village game, and associate such user-provided content with the corresponding persons (e.g., villagers) such that other players may search and access such user-provided content in addition to finding family information from the external databases 2114. The internal database 2116 may be stored with the same family village game server 2110, or may be stored in one or more separate servers that are associated with the family village game server 2110 as an internal server to the Family Village game. Moreover, some portions or all of the internal databases 2116 may be stored locally on one or more of the player computers 2112A, 2112B, etc.

### Uploading User-Provided Content

FIG. 22 is a screen shot of a family archive window 2200 of the Family Village game. The family archive window 2200 may be opened by the player by selecting a “Family Archives” icon displayed by the lower dashboard 116 (FIG. 2). The family archive window 2200 may display a plurality of villagers 2210 associated with the Family Village game. As discussed above, the plurality of villagers 2210 may be real people represented by an avatar in a virtual world, and which may be related to the player of the Family Village game. The family archive window 2200 may show the avatar for the villager 2210 as well as the name of the villager 2210. A search field 2212 may be included for the player to search for a name of a villager 2210 from among those villagers 2210 associated with the player's Family Village game. Thus, the villagers 2210 displayed on the family archive window 2200 at a single time may not represent all villagers 2210 associated with the player's Family Village game. Additional villagers 2210 may also be found through manually browsing through the villagers 2210.

From the family archive window 2200, the player of the Family Village game may select one of the villagers 2210 to enter the “villager's museum.” The villager museum may be selected for a desired villager by selecting on a book icon, which is shown in the lower right-hand corner of the desired villager's avatar picture in FIG. 22. FIG. 23 is a screen shot of a villager museum 2300 that may be opened for a particular villager. The villager museum 2300 may display the avatar and name of the villager, as well as other items that may be associated with that particular villager. From the villager museum 2300, user-provided content may be viewed and/or added to the Family Village game, for example, by selecting a content book shown in the villager museum 2300.

FIG. 24 is a screen shot of a content book 2400 associated with a villager. The content book 2400 may display additional information associated with the villager. At content locations 2410, information associated with the villager may be displayed. A menu 2414 may be used to select the type of information to be displayed by the content book 2400. For example, “user generated content” (i.e., user-provided content) may be selected to show user-provided content associated with the villager. As shown in FIG. 24, no user-provided content is currently present for the selected villager. User-provided content may be added by selecting an add button 2414.

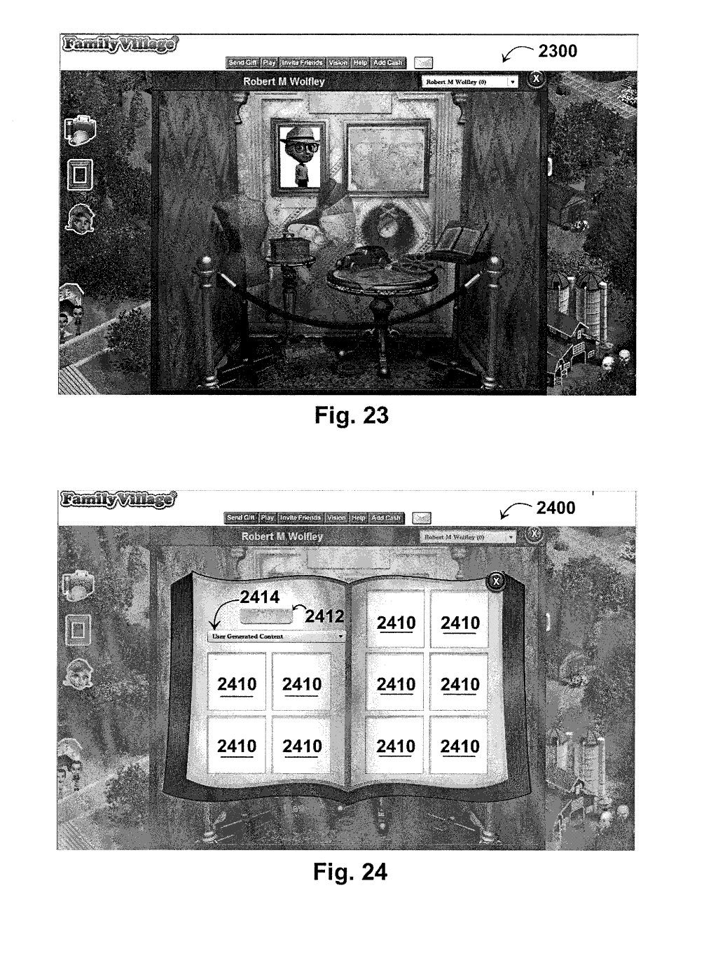

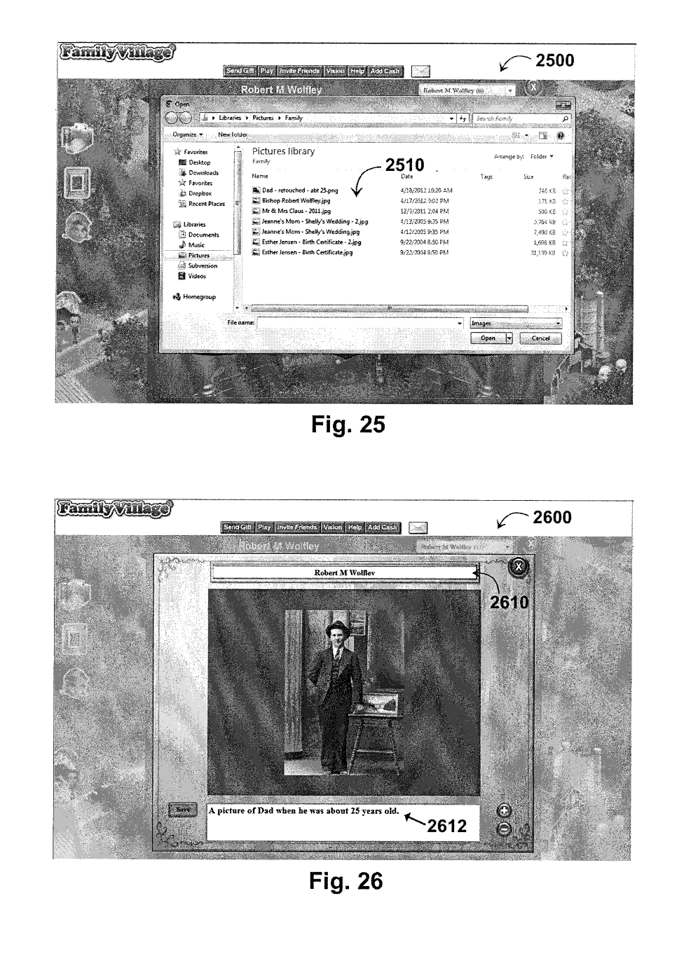

FIG. 25 is a screen shot of an explorer window 2500 that may be opened responsive to the player selecting the add button 2412 of FIG. 24. Thus, selecting the add button 2412 may open an operating system explorer window 2510. In the explorer window 2510, files 2510 may be shown that are available for upload to the Family Village game as user-provided content. As discussed above, user-provided content may include various real-world documents uploaded to the Family Village game by a player. For example, user-provided content may include images, documents, audio files, video files, and other user-provided content is contemplated as being any type of real-world source information dealing with any person associated with the Family Village game. Such content may be configured according to various formats and file types, including .jpg, .gif, .png, .pdf, .doc, .mpeg, .mp3, etc. The Family Village game may upload the file. In some embodiments, the Family Village game may reference the file's location on the player's system. The Family Village game may scan the file and add additional metadata to the file. The file may be scanned for viruses and its file size may be reduced for storage.

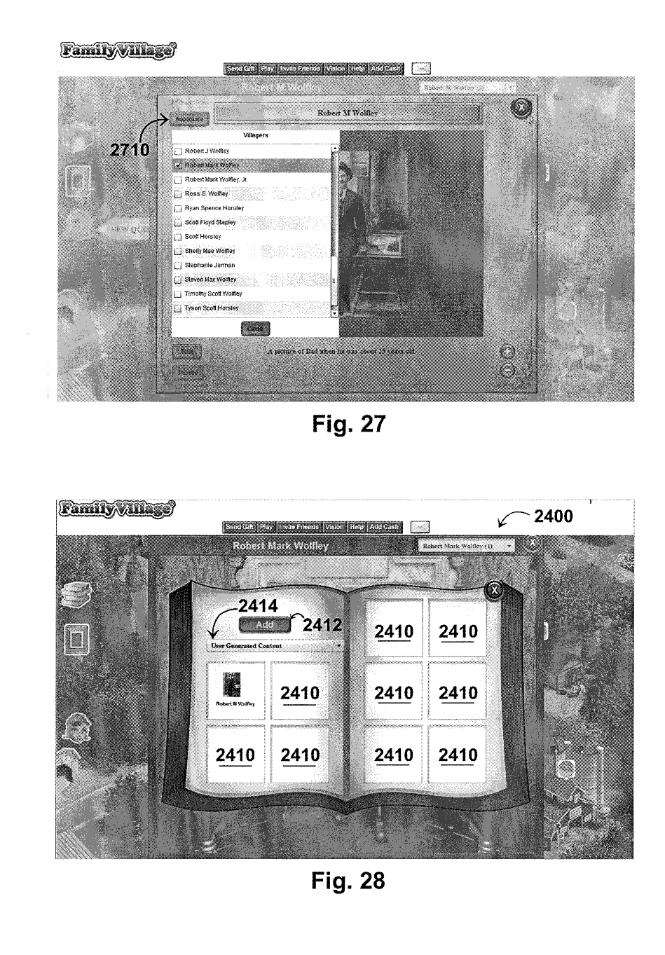

FIG. 26 is a screen shot of a viewing window 2600 that may be opened responsive to a file being selected. The user-provided content (e.g., photo) may be displayed in the viewing window. In addition, the player may add additional information, such as a title 2610 and/or a description 2612 of the user-provided content, which may be saved with the user-provided content. FIG. 27 is a screen shot of the viewing window 2700 that may be opened responsive to an associate button 2710 being selected. Through the menu that is displayed, the player may associate the user-provided content with one or more villagers of the Family Village game by selecting the name associated with the desired villagers to be associated with the particular file. FIG. 28 is a screen shot of the content book 2400 showing the newly added user-provided content in one of the content locations 2410.

### SUMMARY

In summary, a game that incorporates teachings of the present disclosure, as well as methods, means and systems for effecting the game, provide many advantages. By way of non-limiting example, the otherwise tedious work of family history research and genealogy has been incorporated into a fun and interesting game that motivates players to do family history research (e.g., an online social networks game in competition with others, etc.). Moreover, an online family history game enables the players to conduct real-life family history research and retrieve real-world information and documents while playing the game. In addition, real-world information and documents may be provided to the online family history game by the players, and which may be shared with other players of the online family history game.

Various changes and additions in the disclosed embodiments can be made within the spirit and coverage of the present disclosure. It will be understood that the disclosure may be embodied in other specific forms by one of ordinary skill in the art without departing from the spirit, characteristics or coverage of the present disclosure. The present example and embodiments are to be considered to be illustrative and not restrictive, and the disclosure is not intended to be limited to the details of the described embodiments. Rather, the disclosure is defined by the claims, and as broadly as the prior art will permit.

What is claimed is:

1. An online family history gaming network, comprising:
a game server configured to execute an online family history game that enables a player to control one or more avatars in a virtual world, each of the one or more avatars representing a real person; and
an internal database configured to store and manage real-world information associated with at least one real person represented by a corresponding avatar.

2. The online family history gaming network of claim 1, wherein the internal database is stored within the game server.

3. The online family history gaming network of claim 1, wherein the game server is further configured to request user-provided content from the player associated with one or more avatars of the player's virtual world.

4. The online family history gaming network of claim 3, wherein the user-provided content includes real-world documents associated with the real person represented by the one or more avatars of the player's virtual world.

5. The online family history gaming network of claim 3, wherein the internal database is configured to store and associate the user-provided content with the appropriate real person represented by the one or more avatars when the user-provided content is uploaded by the player.

6. The online family history gaming network of claim 5, wherein the internal database is further configured to enable other players of the online family history game to access the user-provided content uploaded by the player.

7. The online family history gaming network of claim 6, wherein the other players enabled to access the user-provided content uploaded by the player are linked to the player.

8. The online family history gaming network of claim 7, wherein the other players enabled to access the user-provided content uploaded by the player are linked to the player in a social media network.

9. The online family history gaming network of claim 6, wherein the other players enabled to access the user-provided content uploaded by the player are unlinked to the player.

10. The online family history gaming network of claim 6, wherein the other players enabled to access the user-provided content uploaded by the player are unknown to the player.

11. The online family history gaming network of claim 3, wherein the user-provided content is a real-world file selected from the group consisting of an image file, a document file, an audio file, and a video file.

12. The online family history gaming network of claim 3, wherein the user-provided content includes one or more of a photograph, a writing, and a certificate.

13. A method for managing family history information of a player of an video game, the method comprising:
associating real-world information for a plurality of avatars representing real people in a virtual world;
querying at least one database for the real-world information in response to a request from a player of a family history game; and
sending the real-world information to the player responsive to the request.

14. The method of claim 13, wherein querying the at least one database includes querying an external database of the family history game.

15. The method of claim 14, wherein the external database includes at least one of a U.S. Federal Census database, a grave database, a newspaper archive database, a government records database, a birth records database, a military records database, a marriage records database, an immigration records database, and a foreign records database.

16. The method of claim 13, wherein querying the at least one database includes querying an internal database of the family history game.

17. The method of claim 16, further comprising updating the internal database with user-provided content uploaded by at least one player of the family history game.

18. The method of claim 17, further comprising sharing the user-provided content with other players of the family history game.

19. The method of claim 13, wherein sharing the user-provided content is limited to a sub-set of players of the family history game.

20. The method of claim 13, wherein querying the at least one database includes querying both an external database of the family history game and an internal database of the family history game for the real-world information in response to the request.
